(19) United States
(12) Patent Application Publication
(10) Pub. No.: US 2010/0207850 A1
(43) Pub. Date: Aug. 19, 2010

(54) MATRIX STRUCTURE OF LED (LIGHT EMITTING DIODE)

(76) Inventor: CHIH-CHIN "ALAN" YANG, Jhubei City (TW)

Correspondence Address: LEONG C LEI, PMB # 1008, 1867 YGNACIO VALLEY ROAD, WALNUT CREEK, CA, 94598, US

(21) Appl. No.: 12/371,926

(22) Filed: Feb. 17, 2009

(51) Int. Cl. G09G 3/32

(52) U.S. Cl. 345/82

(57) ABSTRACT

The present invention is to provide a matrix structure of LED that is a matrix composed of two horizontal scan lines and two vertical scan lines. There is separately set the first and second LEDs with their one ends connect-assemble with the horizontal line and their other ends connect-assemble with the vertical line at the cross points of each horizontal scan line and each vertical scan line. And, each LED has two or more than two light source points with their positive/plus and negative/minus circuitry reversed. By utilizing the method of alternately outputting the positive/plus and negative/minus voltages to horizontal scan lines and vertical scan lines, the four first LEDs and four second LEDs are driven simultaneously. And, while the positive/plus and negative/minus voltages are alternately output, every LEDs all have one light source points lightened such that a matrix is formed to control sixteen LEDs and has the form with eight light source points alternately flashing.

### PRIOR ART OF THE INVENTION

The known LED matrix 10 constructed from two parallel scan lines and two vertical scan lines, as shown in FIG. 1, is formed by mutually interlaced first horizontal scan lines 101, second horizontal scan lines 102 and first vertical scan lines 103, second vertical scan lines 104. There are set separately with LEDs 11, 12, 13 and 14 at each cross points of horizontal scan lines 101, 102 and vertical scan lines 103, 104. The anode pole of each LED is connected with the first horizontal scan line 101 or second horizontal scan line 102, and the cathode pole is connected with the first vertical scan line 101 or second vertical scan line 102. The said matrix is thus capable of driving 4 LEDs.

Its driving method is to output the positive/plus voltage to the first, second horizontal scan lines 101, 102 and to output the negative/minus bias voltage to the first, second vertical scan lines 101, 102 then the LEDs 11, 12, 13, and 14 are all conducted and lightened. And, while the positive/plus voltage is also outputted to the first vertical scan line 103, the LEDs 11, 13 then cannot to be conducted and lightened. And, while the positive/plus voltages are also output to the first and second scan lines 103, 104, the LEDs 11, 12, 13, and 14 also cannot to be conducted and lightened.

Although the known LED matrix can achieve the function of controlling the driving of LEDs, each crossed horizontal line and vertical scan line can only connect-set a LED. Therefore, the whole matrix constructed from two parallel scan lines and two vertical scan lines can drive totally four LEDs. And, it is unable to drive more LEDs and unable to elaborate the maximum efficiency. It thus waits to be improved.

### SUMMARY OF THE INVENTION

The matrix structure of the LED in the present invention mainly is to separately set the first and second LEDs with their one ends connect-assemble with the horizontal line and their other ends connect-assemble with the vertical line at the cross points of each horizontal scan line and each vertical scan line. And, each LED has two or more than two light source points with their positive/plus and negative/minus circuitry reversed such that the whole matrix is formed to control sixteen LEDs. And the LED matrix structure with the form of eight light source points alternately flashing has greatly upgraded the efficiency of the said LED matrix.

### BRIEF DESCRIPTION OF THE DRAWINGS

FIG. 1 is a dispose-set diagram of the LED matrix in the prior art.

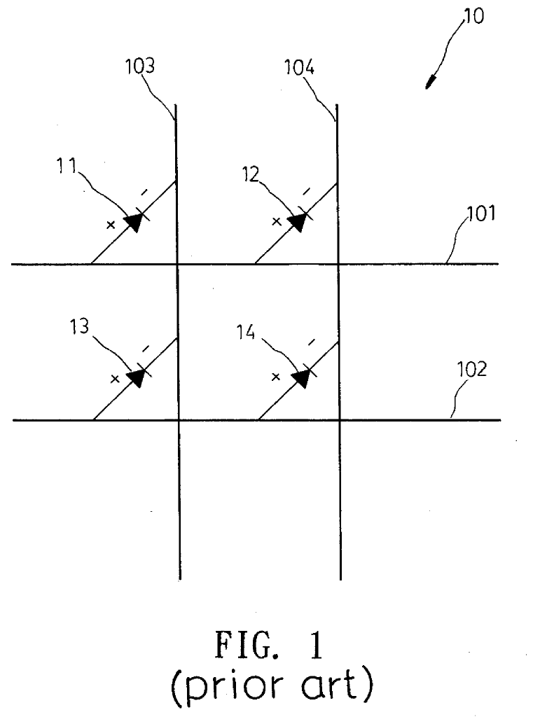

FIG. 2 is a dispose-set diagram of the LED matrix according to the present invention.

### DETAILED DESCRIPTION OF THE PREFERRED EMBODIMENT

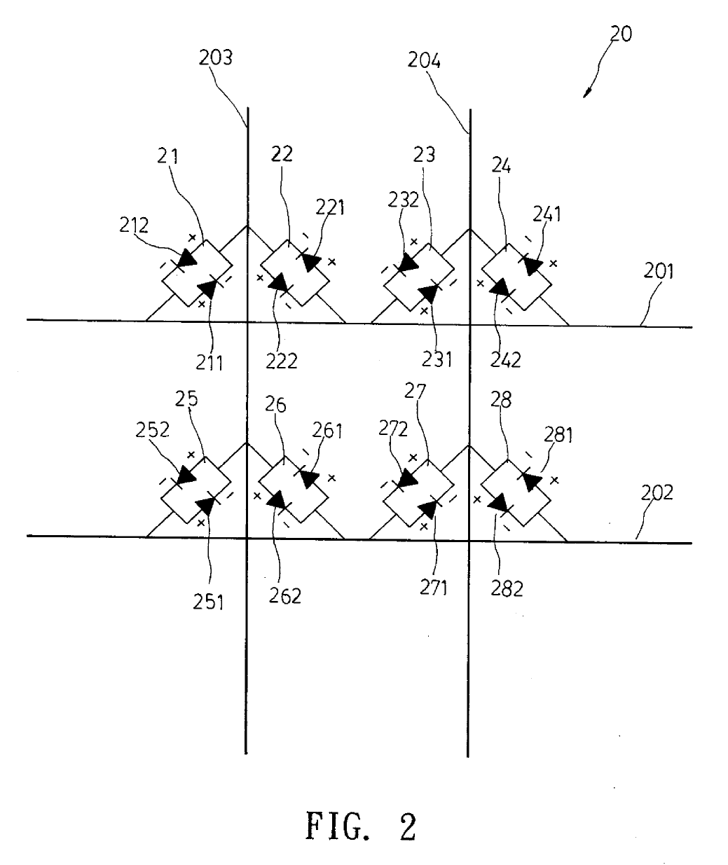

Please refer to FIG. 2. The LED matrix 20 of the present invention is formed by mutually interlaced first horizontal scan lines 201, second horizontal scan lines 202 and first vertical scan lines 203, second vertical scan lines 204. There are set separately with first LEDs 21, 23, 25, 27 and second LEDs 22, 24, 26, 28 at four cross points of each horizontal scan lines 201, 202 and each vertical scan lines 203, 204. One end of each LED is connected with the first horizontal scan line 201 or second horizontal scan line 202, and the other end is connected with the first vertical scan line 203 or second vertical scan line 204. And, each LED has two or more than two light source points with their positive/plus and negative/minus circuitry reversed.

Furthermore, in the first LEDs 21, 23, 25, 27, there separately are light source points 211, 231, 251, 271 with their anode poles conductively connected with the first horizontal scan line 201 or second horizontal scan line 202 and with their cathode poles conductively connected with the first vertical scan line 203 or second vertical scan line 204, and light source points 212, 232, 252, 272 with their anode poles conductively connected with the first vertical scan line 203 or second vertical scan line 204 and with their cathode poles conductively connected with the first horizontal scan line 201 or second horizontal scan line 202. And, in the second LEDs 22, 24, 26, 28, there separately are light source points 221, is 241, 261, 281 with their anode poles conductively connected with the first horizontal scan line 201 or second horizontal scan line 202 and with their cathode poles conductively connected with the first vertical scan line 203 or second vertical scan line 204, and light source points 222, 242, 262, 282 with their anode poles conductively connected with the first vertical scan line 203 or second vertical scan line 204 and with their cathode poles conductively connected with the first horizontal scan line 201 or second horizontal scan line 202.

Their driving methods are that the light source points 211, 231, 251, 271 in the first LEDs 21, 23, 25, 27 and the light source points 221, 241, 261, 281 in the second LEDs 22, 24, 26, 28 are all able to be conductively lightened while the first, second horizontal scan lines 201, 202 are output positive/plus voltages and the first, second vertical scan lines 203, 204 are output negative/minus voltages, and the light source points 212, 232, 252, 272 in the first LEDs 21, 23, 25, 27 and the light source points 222, 242, 262, 282 in the second LEDs 22, 24, 26, 28 are all able to be conductively lightened while the first, second horizontal scan lines 201, 202 are output negative/minus voltages and the first, second vertical scan lines 203, 204 are output positive/plus voltages. By utilizing the method of alternately outputting the positive/plus and negative/minus voltages to horizontal scan lines and vertical scan lines, the four first LEDs 21, 23, 25, 27 and four second LEDs 22, 24, 26, 28 are driven simultaneously. And, while the positive/plus and negative/minus voltages are alternately output, every LEDs all have one light source points lightened such that a matrix is formed to control sixteen LEDs and has the form with eight light source points alternately flashing.

The aforementioned first LEDs 21, 23, 25, 27 and second LEDs 22, is 24, 26, 28 can be disposed of lights with same colors or different colors.

I claim:

1. A matrix structure of LED being a matrix composed of two horizontal scan lines and two vertical scan lines, is separately set the first and second LEDs with their one ends connect-assemble with the horizontal line and their other ends connect-assemble with the vertical line at the cross points of each horizontal scan line and each vertical scan line, and each LED has two or more than two light source points with their positive/plus and negative/minus circuitry reversed.

2. A matrix structure of LED according to claim 1, wherein the two sets of light source points in the first LED and second LED can be disposed of lights with same colors or different colors.
